(19) United States
(12) Patent Application Publication
(10) Pub. No.: US 2007/0114074 A1
(43) Pub. Date: May 24, 2007

(54) Wheel supporting device for vehicles

(76) Inventors: Sven A. Jansson, Gottby,Aland (FI); Karl-Johan Edlund, Mariehamn, Aland (FI)

Correspondence Address: CHARLES E. BAXLEY, ESQ., 90 JOHN STREET, THIRD FLOOR, NEW YORK, NY, 10038, US

(21) Appl. No.: 10/554,491

(22) PCT Filed: Apr. 23, 2004
(86) PCT No.: PCT/SE04/00623

§ 371 Date: Oct. 24, 2005

(30) Foreign Application Priority Data
Apr. 25, 2003 (SE) 0301208-5

(51) Int. Cl. B62D 11/02; B60G 9/00

(52) U.S. Cl. 180/6.48; 280/124.1

(57) ABSTRACT

A wheel supporting system for vehicles in which the wheel (1) is supported by a fork (10) with at least one bracket (10a, 10b), on which the wheel (1) is journalled rotatable round a horizontal axle. The fork (10) is turnable round a vertical axle and controllable by a turning mechanism (17). The turning mechanism with shock-absorbers (5, 19, 23-26) is vertically movable and fixed to a bracket (3, 32) which is vertically adjustable by means of shifting mechanisms (6, 20.22, 28-31), in relation to a support (4, 35) fixed to the chassis.

### AREA OF INVENTION

The present invention is of a supporting system for vehicle wheels.

### TECHNICAL STATUS

A wheel supporting system must be able to transfer power to the wheel while, at the same time, allowing the wheel to move in relation to the vehicle chassis, partly vertically through spring action and partly, at least for two wheels, allowing the wheels to be turned round a vertical axle in the steering action. All these requirements are generally fulfilled by the use of torsion axles with ball links or steering rods. In order to allow the axle extension lines of the wheels engaged in the steering action to cross each other at one and the same point, the pole, the wheels must be connected to each other by a parallel rod. This is necessary to enable the wheels to roll without skidding in a road bend. To enable the wheels to move vertically in spring action while retaining their track distance various types of linking rods and steering rods are used in the supporting.

Proposals have been made for so-called hybrid vehicles in which the secondary effect derives from an electric motor jointly connected to one or two pairs of wheels. In this system, too, the moment is transferred to the wheels by means of torsion axles with differential gears.

Further, there are proposals for electric, pneumatic or hydraulic wheel motors in which at least the torsion axles are replaced with flexible cables or tubes, but in these cases, too, the wheels are turned when steering by steering rods with ball links.

When the vehicle is being driven in rough country there is a need to increase the road clearance. When driving on smooth roads a low clearance may be allowed and at high speed a low clearance is desirable to keep the centre of gravity low. There are systems on the market which fulfil these requirements. It may also be the case that the front wheels and the rear wheels should be at different distances from the road surface depending on the load. It may even be desirable that one side is higher than the other, that is to say, the vehicle need to be able to bank or lean in a road bend. It is essential that clearance adjustment can be carried out for each of the four wheels individually.

### PRINCIPLE OF INVENTION

The present invention eliminates the drawbacks of the supporting systems known at present and fulfils the requirements mentioned above, which can be realized through the characteristics mentioned in the patent claims. It also applies to the case where the driving wheels contain individual wheel motors of an electric, pneumatic or hydraulic type. Its main advantage is that it enables all the wheels to take up a transverse position, which drastically simplifies parking. However, the invention may also be applied in cases where the wheels are driven mechanically by a ball link, although in such cases a 90 degrees turning of the wheels is not possible.

The basic principle is shown in the FIGS. 1-4 where:

FIG. 1 shows a side section of the wheel supporting according to the present invention. The figure left of the centre line shows the wheel supporting when the wheel is not under pressure or the spring is in an open position and with the lowest possible clearance. The figure shows the wheel right of the centre line when it is under maximum pressure and the spring is depressed, and the chassis is raised to the highest possible clearance position.

FIG. 2 shows a horizontal section of the wheel supporting of FIG. 1.

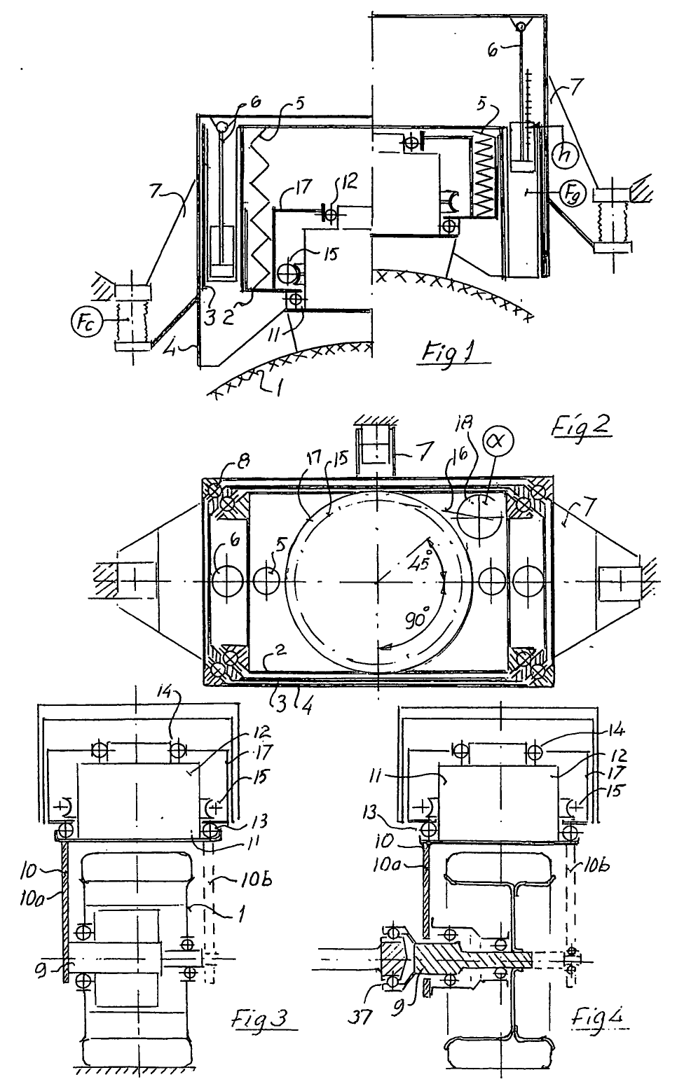

FIG. 3 shows a transverse section of the vehicle with an electric wheel motor.

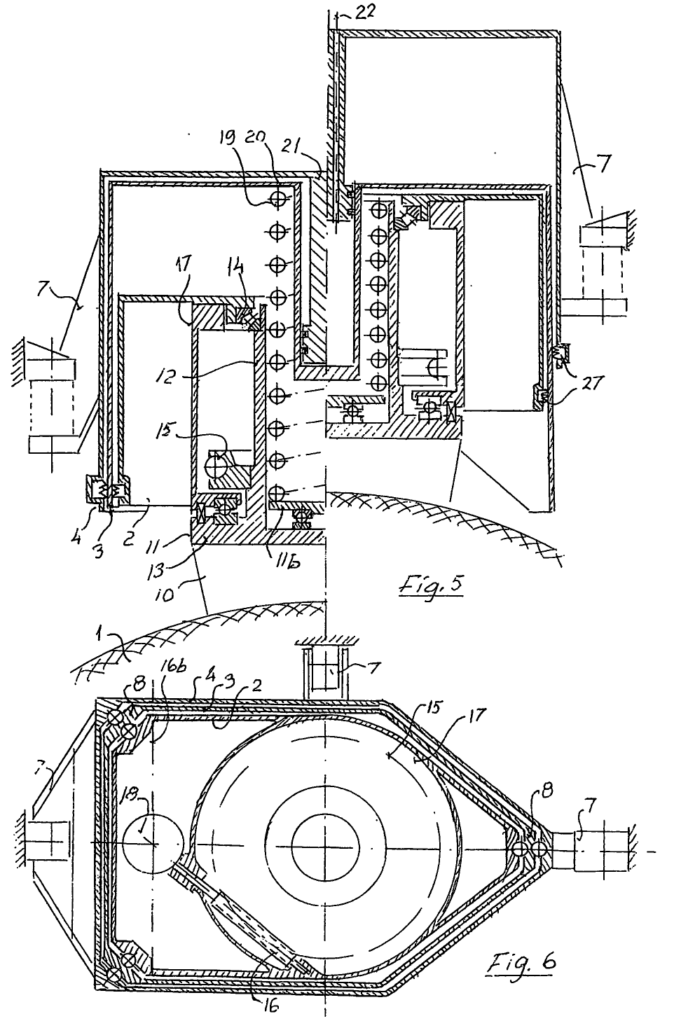

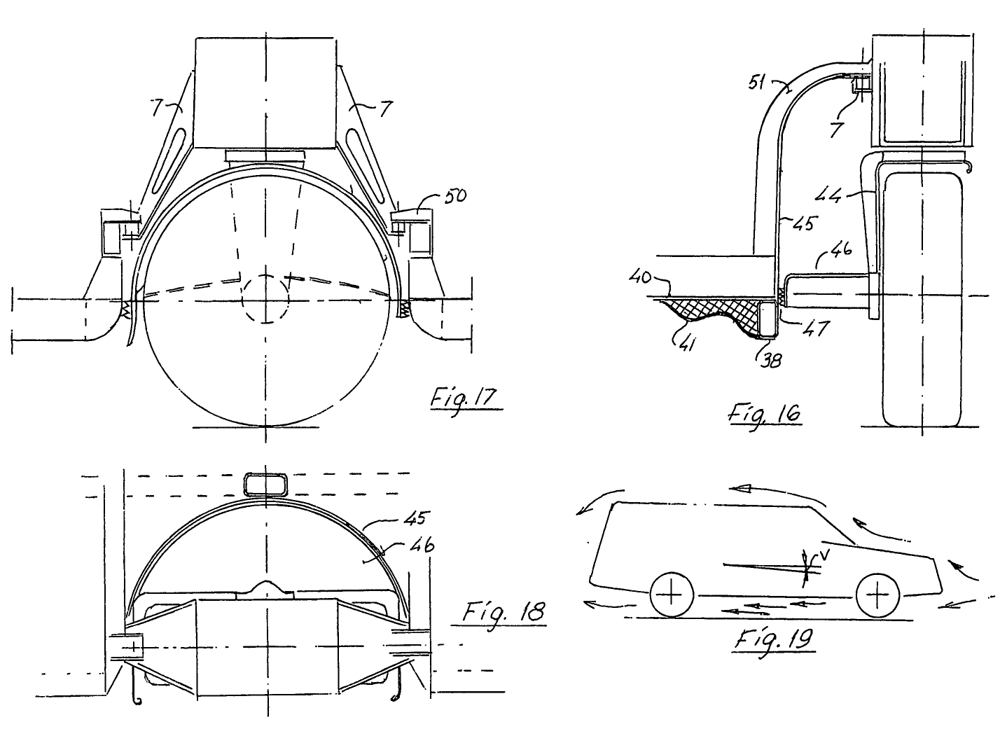

FIG. 4 shows the variant with a mechanically driven wheel. Different designs and applications appear in FIGS. 5-19, in which:

FIG. 5 is a longitudinal section of the vehicle with a variant of the wheel mechanism in which the spring action is performed by a mechanical spring placed in the centre of the mechanism. Left of the centre line, the spring is shown in its unloaded state with the wheel system set for minimum clearance. To the right in the figure the system is shown with the spring depressed with the mechanism set for maximum clearance.

FIG. 6 shows a horizontal section of the mechanism.

FIG. 7 shows a longitudinal section of a variant of the wheel mechanism in which a gas-hydraulic spring at the centre of the vehicle is used to perform the springing action.

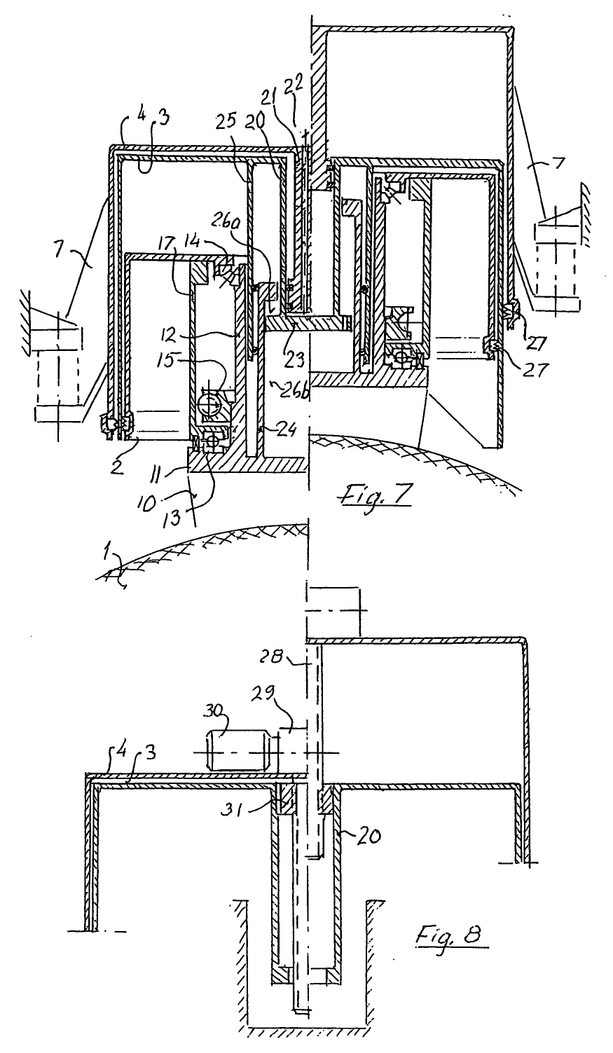

FIG. 8 shows a section of the upper part of a system in which an electrically powered motor-driven mechanical screw jack is used as a movement device.

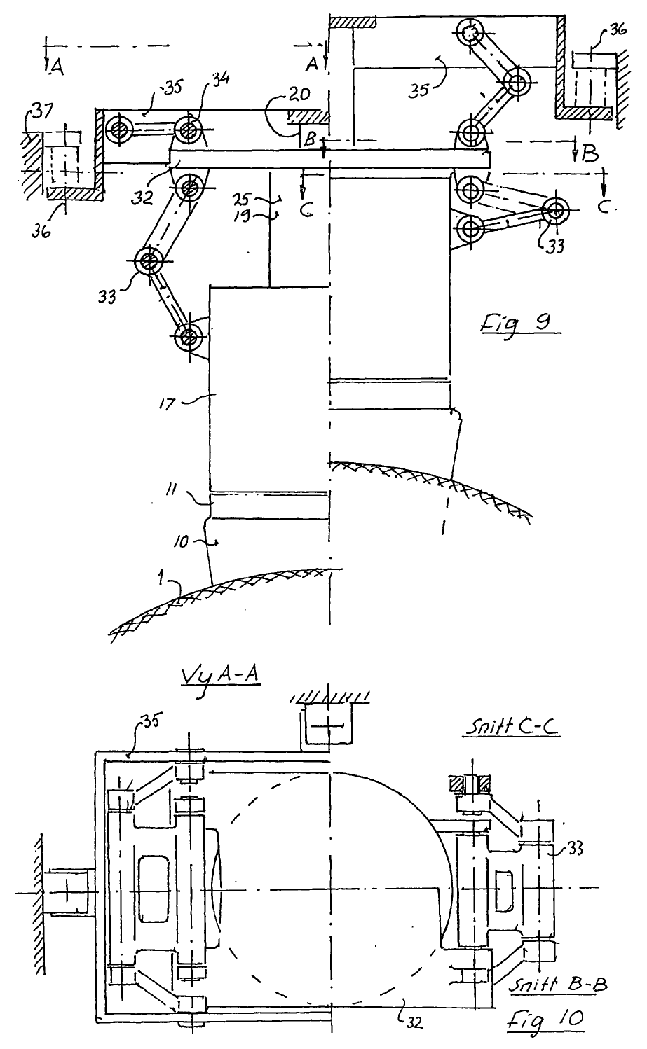

FIG. 9 shows a longitudinal section of a mechanism in which, instead of the cassette boxes referred to above, link rods are used to guid the spring action and the lifting action to adjust the clearance.

FIG. 10 shows several horizontal sections and views of the mechanism in the previous figure.

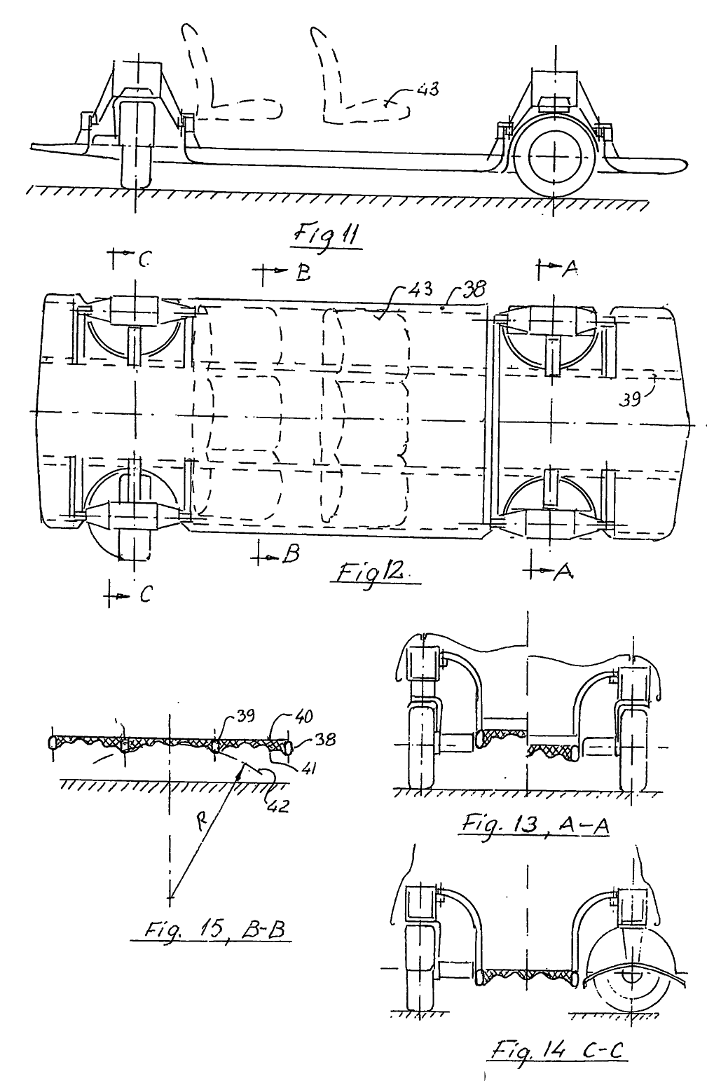

FIGS. 11-15 show how the wheel mechanism can be fixed to a bottom plate on the vehicle chassis. The right rear wheel is shown in a transverse position and in FIG. 13 the left front wheel is set for high clearance.

FIGS. 16-18 show details of how the wheel mechanism is mounted on, and fixed to, the bottom plate.

FIG. 19 shows the air flow around a vehicle.

The aim of the present invention is partly to enable the wheel to have a spring movement range of about 80 mm and partly to enable the chassis to be raised by about 100 mm in relation to the wheel axle. This is possible as the wheel 1 is fixed to the bottom of a box 2, which is vertically movable inside a second box 3, which is inside a third box or cassette 4. The first box 2 is connected to the second box 3 by springs 5 and a shock absorber (not shown) in order to give the wheel springing action on a rough road surface.

The second box 3 and the cassette 4 are connected to the movement mechanism 6 by mechanical jacks or air or oil cylinders. Since the cassette 4 is fixed to the vehicle chassis by ears, the chassis can be raised or lowered by activating the movement mechanism 6. In order to ensure that the different boxes move with the minimum degree of friction and to eliminate the risk of jamming, they are controlled by ball guides 8.

In FIG. 1 to the left of the centre line is shown the wheel supporting when the wheel is not under pressure or the spring is not depressed and the clearance is at the lowest setting possible. To the right of the centre line in the same figure is shown the wheel mechanism when the wheel is under maximal pressure, the spring is depressed and the chassis raised to maximum clearance. The aim is also to enable the wheel to turn at least 45 degrees in one direction and 90 degrees in the opposite direction round the vertical central axle of the wheel. This is possible as the axle of the wheel 9 is supported by a fork 10 with one or two brackets (10a, 10b) from a disc 11, which, together with its stub axle 12 and ball bearings 12, 13, is journalled in the inner box 2 mentioned above. One 13 of these bearings is of a type that can absorb axial forces and moments at right angles to the stub axle 12. The stub axle of the wheel fork 10 has a worm wheel 15, interacting with the screw 16 in a worm gear 17. The worm gear 17 is driven by a “Can”-controlled step motor 18, which turns the wheel 1 by steering impulses from the driver's seat. For reasons of safety, these steering impulses must be regressive in relation to the steering wheel movements and follow a programme in which the steering radius and the speed of the vehicle are parameters. It is taken as understood that the wheel can be turned either by a pneumatic or a hydraulic control system. The design described above can also be used in cases where the wheel is driven mechanically by means of a universal joint 37, FIG. 4, but the turning ability of the wheel is limited by the angular adjustment range of the universal joint.

A supporting system according to the present invention may easily include sensors for factors of importance for the safe handling of the vehicle. The turning angle of the wheels alfa can be derived from the steering impulses going to the positioning motor 18. The sideways pull on the vehicle in bends or the centrifugal force Fc can be gauged by an accelerometer or pressure sensor in one of the fixing bolts 7. The weight of the vehicle Fg can be derived from the impulses going to the mechanism for raising and lowering the vehicle 6 and this movement h can be gauged simply with a position sensor in the same mechanism.

### DESIGNS ACCORDING TO PRINCIPLE

A detailed description of the present invention with references to the figures:

FIGS. 5 and 6: The vehicle wheel 1 is supported by a fork 10 with one 10a or two 10b brackets from a disc 11 with an axle stub 12. The axle stub 12 is journalled with ball bearings 13, 14 in a gear box 17. The gear box 17 is built into a box 2, which is vertically movable within a box 3. Its mobility is facilitated by ball guides 8 placed in three or four of the corners of the box. The boxes can be made quite rectangular with four corners, but also, as is shown in FIG. 6, with five corners, so that one short side is wedge-shaped. The stub axle 12 is hollow, so that a spring coil 19 can be placed inside it which at the lower end rests on the fork disc 11 via a journalled washer 11b and at the top end pushes against the ceiling of the box. The spring 19 can thus absorb and damp shocks from the wheel caused by bumps in the road.

Mounted on the stub axle 12 is the worm wheel 15, which, together with the worm screw 16, is part of the worm gear 17, which makes it possible, by means of an electric motor 18, to turn the wheel fork 10 in order to steer the vehicle. If faults develop in the electrical system of the positioning motor 18, in an emergency, the wheel fork can be steered mechanically by connecting an axle with a ball joint from an emergency steering wheel to a spare axle 16b on the angular gear of the positioning motor.

The box 3 mentioned above is movably mounted in a cassette 4, which is fixed by means of ears and screws 7 to the sub-frame of the vehicle. Here, too, mobility is facilitated and controlled by ball guides 8 in the corners of the boxes. A cylinder 20 containing a piston with a rod 21 is fixed to the roof of the box. Thus the cassette 4 along with the chassis, which are fixed together, can be raised in relation to the wheel axle by the induction of hydraulic oil or compressed air through a duct 22, which is shown to the right of the centre line of the section in FIG. 5. In order to prevent the introduction of sand and other impurities into the gaps between box 2, box 3 and cassette 4, strip seals of the scraping—tongues type are applied at their lower edge.

A variant of a spring coil system is shown in FIG. 7. Here the cylinder 20 mentioned above is shaped like a piston 23 on the outside, which moves in a second cylinder 24, which ,in its turn, functions as a piston moving inside a third cylinder 25, extending from the roof of the box 3. The space on either side 26a, 26b of the first piston 23 is filled with hydraulic oil, which can flow through nozzles in the piston, the area of the nozzles determining the speed of the motion. The upper space between the latter piston 24 and the cylinder 25 is filled with inert gas.

Oil and gas are replenished through connections and ducts not shown in the figure.

As the functioning of this gas-hydraulic spring is well known from other contexts, for example the undercarriage of aeroplanes, it is not further described here. Gasket rings are inserted to tighten the pistons in the normal way.

In FIG. 8 a variant is shown of the wheel mechanism in which the piston 21 described in FIG. 5 is replaced with a screw 28, which is turned, via an angular gear 29, by an electric positioning motor 30. The screw 28 moves in a nut 31 which is fixed inside the cylinder 20 mentioned above, which is fixed in the box 3. When the screw 28 turns, the cassette 4 and, together with it, the whole chassis are raised.

In the design of the mechanism according to FIG. 9, the worm gear box 17 is connected to a disc 32 by linking arms 33 on either side and this disc 32 is, in its turn, linked by similar arms to a frame 35, which is fixed to the chassis 37 by vibration-absorbing screws 36. The spring coil 19 described above in FIG. 5 is fixed to the disc or the cylinder 25 in FIG. 7. The cylinder 20 referred to above and its piston are also included in the design. FIG. 9, which presents a sideways view of the mechanism, shows, to the left of the central line, the mechanism with the spring coil unloaded and set for the lowest clearance. To the right of the centre line in the same figure the mechanism is shown under maximum pressure with the chassis raised for maximum clearance. FIG. 10 shows the same mechanism seen from above or in several different horizontal sections.

In the present design the frame 35 corresponds to the cassette 4 and the plate 32 corresponds to the box 3 and the gear box 17 corresponds to the box 2 in the previous versions of the design. An advantage of the invention is that the chassis can be made as a plane bottom plate to which the cassette box 4 can be fixed. This is described in more detail in FIGS. 11-15. The bottom plate consists of outer longitudinal hollow girders 38 and central hollow girders 39, which are held in position by a smooth top plate 40, which is the floor of the vehicle cabin, and an outer corrugated bottom sheet 41 with longitudinal grooves. The corrugation of the bottom sheet has an arching profile 42 from the ground a 1 m radius R between the girders. This causes the longitudinal air currents to develop between the plate and the ground, which helps the vehicle to stay on course. The space between the smooth top plate and the corrugated bottom plate can be filled with light foam material in order to stabilize the plates and provide heat and noise insulation.

Since the supporting system just described lacks steering rods and power axles (for electric wheel motors), the sub-frame with the supporting mechanism in combination with the bottom sheet will have no interfering elements which can catch on bumps in rough ground. In addition, there is no air turbulence under the vehicle and its total air resistance will be reduced, which makes for much improved running economy at high speed.

In order to improve the air flow between the wheels and the bottom plate, the wheels can be surrounded by screens, which are shown in detail in FIGS. 16-18. On the inside of the wheel, against the fork, a half-moon shaped plate can be mounted, which changes into a mudguard 44 at the upper half of the wheel. A slightly upwards arching torsion disc, positioned between the wheel and the inner wall of the wheel house 45, follows the turning motion of the wheel. In this motion the disc 46 packs tightly against the wall of the wheel house 45 with an elastic tongue 47. The disc also 46 helps to maintain an even air flow in the wheel houses and around the wheels as well as prevents mud from splashing on the inner walls of the supporting mechanism. All four supporting mechanisms can be of identical design whether for electric power and four-wheel steering or each pair of wheels identical with two-wheel mechanical drive or two-wheel steering. The fixing procedure to the bottom plate for two wheels is the same as for four wheels and is easily performed when the vehicle is jacked up by pushing the mechanism up from below towards the brackets 50 and 51, to which it is then fixed with vibration-absorbing bolts. Conversely, the wheel units can be easily dismantled for service. Checking and maintenance can then be carried out at special service stations which have facilities for easy access to all vital parts, such as tyres, wheels and brakes, wheel motors and steering systems.

Another advantage of the supporting system according to the present invention is that the steering action takes place by means of electric signals in cables, which makes a mechanical steering wheel and a steering column superfluous. The space in front of the driver's seat 43 is therefore free both at seat level and, because of the bottom plate just described, also at foot level. Hence the driver's seat can be designed to give the driver a choice of three positions in which to sit: on the left, as in vehicles for right-hand traffic, in the centre, which is the safest position, and on the right, as in vehicles for left-hand traffic. Thus the driver can sit where he feels safest and most comfortable. This system reduces the risk of dazzling in darkness if the driver, in right-hand traffic, sits on the right or furthest away from the meeting light beam. Similarly, the risk of parking accidents is reduced if the driver, in right-hand traffic, sits on the right and is able to get out of the car onto the pavement to the right—not to the left into the flow of the traffic!

A further advantage of the present invention is that the front and the rear of the car can be set at different elevations. This may be necessary to compensate for an uneven load distribution, but also to control the air flow round the vehicle. A wheel supporting system and a vehicle bottom designed according to the present invention ensures an even air flow free from interference around the vehicle (FIG. 19). This air flow will provide a downward pressure which helps to keep the vehicle on the road, especially at high speed, provided the inclination of the bottom, expressed with the angle of incidence of the air v, is correct.

1. The supporting of vehicle wheels in which the wheel (1) is supported by a fork (10) with at least one bracket (10a, 10b), on which the wheel (1) is journalled rotating round a horizontal axle, so that the fork (10) is made turnable round a vertical axle and controllable by a turning mechanism (17) is characterized by the turning mechanism (17) being housed in a box structure (2), in whose bottom the wheel (1) is fixed. This box structure (2), which, with shock-absorbing elements (5, 19, 23-26), is vertically movable and attached to a bracket (3,32), which, by means of a shifting mechanism (6, 20-22, 28-31), is vertically adjustable in relation to a supporting mechanism (4, 35) fixed to the vehicle chassis.

2. The supporting according to claim 1 is characterized by the box structure (2) being movable inside cassette box (3), whose bottom is open and whose top is closed with a lid. The movement of the box structure is controlled by ball guides (8) in at least two corners and one side of the boxes.

3. The supporting according to claim 1, 2 or 3 is characterized by the box structure (2) being movable vertically in relation to a disc (32) whose function is to provide resistance to the spring elements (19,25) during steering by means of link arms (33) on either side. The disc (32) can also move vertically in relation to a frame (35) fixed to the chassis during steering by means of a second pair of link arms (34) controlled by jacks (20) in order to change the vehicle's road clearance.

4. The supporting according to one of claims 1-3 is characterized by the turning mechanism comprising a worm gear unit (17) connected to the wheel fork (10) and controllable by means of an electric, hydraulic or pneumatic shifting motor (18).

5. The supporting according to claim 1 or 2 is characterized by the wheel fork (10) comprising a disc (11) with a stub axle (12). As shock absorbers are used one or several gas-hydraulic spring coils (19), which are placed in the cavities of the stub axle (12) of the fork disc (11) and which, at the bottom end, press against the fork disc (11) and at the top end against the lid (3) of the cassette box.

6. The supporting according to claim 1 or 2 is characterized by having, as a shock-absorbing mechanism, a gas-hydraulic spring, functioning in the normal way and consisting of a hollow piston rod (24) moving in a cylinder (25) fixed to the lid of the cassette box (3). The space between the first piston rod (24) and the cylinder (25) is filled with inert gas. A second hollow piston rod (20) with a piston (23) moves in the hollow of the first piston rod (24), and the upper (26a) and (26b) the lower space between these is filled with hydraulic oil, whose pressure can be stabilized when the first piston rod (24) moves through the oil flowing through nozzles in the second piston (23).

7. The supporting according to claim 2 is characterized by the wheel (1) and the cassette box (3) being able to move vertically because a cylinder (20) is fixed to the lid of the cassette box (3), in which a piston and a piston rod (21) move and hydraulic oil under pressure is replenished or drawn off in the space between the cylinder (20) and the piston rod (21) in order to change the clearance of the vehicle.

8. The supporting according to claim 2 is characterized by the wheel (1) and the cassette box (3) being able to move vertically, because an electric shifting motor (30) drives, via a gear unit (29), both attached to an element fixed to the chassis (4), a threaded spindle (28) moving through a nut (31) fixed to the lid of the cassette box (3). This system is able to change the clearance level of the vehicle.

9. The supporting according to claims 2-8 is characterized by the wheel fork (10), by means of steering signals from the driver's seat to the shifting motor, being turnable at least 45 degrees in one direction and 90 degrees in the other. The turning movement of two or four wheels (1) is electronically linked by means of a computer programme in a central unit, so that the extension lines of the wheel axles cross each other at a common pole point.

10. The supporting according to claims 1-9, fixed to a bottom plate in the chassis, is characterized by the bottom plate consisting of longitudinal tubular girders (38,39), connected by an upper plane plate (40) and a bottom corrugated plate (41) with longitudinal grooves. Between the girders (38,39), the bottom plate has a medium profile (42) arched from the ground. The space between the sheets is filled with sound and heat insulating material.
